(19) United States
(12) Patent Application Publication
(10) Pub. No.: US 2015/0134350 A1
(43) Pub. Date: May 14, 2015

(54) SYSTEM AND METHOD FOR OPTIMIZING PATIENT MANAGEMENT IN A CARE FACILITY

(71) Applicant: Clifton R. Lacy, Highlands, NJ (US)

(72) Inventor: Clifton R. Lacy, Highlands, NJ (US)

(21) Appl. No.: 14/535,982

(22) Filed: Nov. 7, 2014

Related U.S. Application Data
(60) Provisional application No. 61/901,536, filed on Nov. 8, 2013.

(51) Int. Cl. G06F 19/00

(52) U.S. Cl. CPC G06F 19/3406
USPC 705/2

(57) ABSTRACT

The present methods and systems are directed to managing and optimizing patient care and experience in an inpatient hospital setting by coordinating the evaluation of patients, the managing and optimizing of patient and asset movements, and the quality of medical care especially during the period of a mass casualty event.

### CROSS REFERENCE TO RELATED APPLICATIONS

The present application claims the benefit of U.S. Provisional Application Ser. No. 61/901,536 filed 8 Nov. 2013, which is incorporated herein by reference in its entirety.

### FIELD

The present disclosure is directed to systems and methods for managing and optimizing patient care and experience in an inpatient hospital setting in general and to the evaluation of patients, the managing and optimizing of patient and asset movements, and the coordination and quality of medical care in an inpatient hospital setting specifically.

### BACKGROUND

Optimal medical care of a patient in a healthcare facility, such as a hospital, necessitates timely evaluation, testing and treatment. This is especially important in situations requiring emergent or urgent care. Currently, through various systems, patients admitted to a medical care facility are evaluated and tested to determine and deliver the best course of treatment. However, due to the number of patients seeking treatment at medical care facilities, especially during periods of high volume, such as flu season or following a disaster or other mass casualty incident, the large patient influx can result in situations where more critical patients are not treated in a timely fashion, either because they have been improperly categorized or the assets for treatment are unavailable because of allocation to less critical patients. Delays and/or mis-categorizations of a patient's status are often due to several factors, which may include a lack of granularity of patient evaluation, a lack of central control that can monitor and control patients and their movement as well as the status and availability of assets within a care facility.

Accordingly, a need exists for a system and method to evaluate better patients in need of medical care, monitor the availability and scheduling of assets and facilities, enhance communications and perform real-time or near-real-time evaluation of patients' needs and asset availability. Further, a need exists for a system and method that minimizes delay in diagnosis and maximizes efficiency, effectiveness, quality, and satisfaction of care. Such a system should also minimize delay in treatment with a goal of maximizing efficiency, effectiveness, quality, and satisfaction of care.

### SUMMARY

Using novel and elaborate evaluation methodology, prioritization of patient needs for diagnostic testing and treatment procedures is established. Real-time locating system technology allows accurate identification of location and direction of movement of human and nonhuman resources in space and time. Computer assignment of sequence, timing, and location of testing and treatment is performed for the entire cohort of patients and/or disaster victims according to priority. Real-time inputs from examination, testing and treatment venues to a master processing center provide situational awareness information for just-in-time allocation of human and nonhuman assets. Real-time outputs from the master processing center provide direction for just-in-time delivery of human and nonhuman assets to testing and treatment venues. Under continuous human supervision, the automated system of the present disclosure manages multiple patients and/or disaster victims in the most efficient and effective manner to maximize efficiency, effectiveness, quality, and satisfaction of care.

In an embodiment a system for managing treatment of a plurality of patients in a facility is disclosed. The system comprising: an input device for inputting a status of the plurality of patients; a processor for determining a treatment priority for the plurality of patients based on the input; assigning, via the processor, the treatment priority to each of the plurality of patients; generating, via the processor, a treatment plan for each of the plurality of patients; and a real time locating system for monitoring and tracking equipment and personnel within the facility; allocating, via the real time locating system, equipment and personnel to implement the treatment plan for each of the plurality of patients; and implementing, via the processor, for the plurality of patients, based on the assigned treatment priority and the allocating of equipment and personnel, the treatment plan.

In an alternative embodiment, the system status is a health status determined by a multilevel assessment. In a further embodiment of the system, the status is updated a plurality of times during the treatment plan. In a further embodiment of the system, the status update is based on a test run on one of the plurality of patients. In a further embodiment of the system, a testing system, is utilized, wherein the testing system maintains the status of the plurality of patients. In still another embodiment, the system comprises a plurality of testing venues to collect the status of the plurality of patients and to provide the collected information to a testing system or the processor. In another embodiment, the allocating of equipment and personnel to implement the treatment plan for each of the plurality of patients is controlled by the processor.

In an embodiment, a system for treating a plurality of patients comprising a master processing center; an examination venue; and a real time locating system is disclosed. Wherein data from the examination venue, and the real time locating system is provided to the master processing system, and wherein the master processing center determines a treatment plan for the plurality of patients based on the data.

In an alternative embodiment of the system, the examination venue is selected from at least one of the following; a testing venue, a treatment venue and an evaluation and care venue. In another embodiment, the testing venue is selected from at least one of the following: a general laboratory, a non-invasive cardiology laboratories, a vascular laboratory, an electroencephalography laboratory, a cardiac catheterization laboratory, a diagnostic cardiac electrophysiology laboratory, a gastrointestinal endoscopy laboratory, a pulmonary function laboratory, a bronchoscopy laboratory, a hematology laboratory, an endocrinology laboratory, a peripheral angiography laboratory, a diagnostic radiology laboratory, a magnetic resonance imaging facilities, a computerized tomography facility, a positron emission tomography facility, a radiography facility, and a ultrasound facility.

In another embodiment, the examination venue is selected from at least one of the following: an examination room, a general or specialized treatment room, a procedure room, a surgical suites, an operating room, a bronchoscopy procedure suite, an endoscopy procedure suite, a cardiac procedure suites, and an interventional radiology suite.

In an embodiment, a method, implemented on a processor and a communications network, for managing the treatment of a plurality of patients in a facility is described. The method includes inputting to the processor, via an input device, a status of the plurality of patients; determining, via the processor, based on the inputting, a treatment priority for the plurality of patients; assigning the treatment priority to each of the plurality of patients; selecting, via the processor, a treatment plan for each of the plurality of patients; tracking equipment and personnel within the facility via a real time locating system located at the facility; allocating the equipment and personnel to implement the treatment plan.

In another embodiment, the method comprises testing the patients in an examination venue, and outputting a test result to be used as input for the processor. In another embodiment of the method, the examination venue is selected from at least one of the following; a testing venue, a treatment venue and an evaluation and care venue. In another embodiment the treatment plan is based on the test result. In another embodiment the method comprises a second testing and an update to the treatment plan based on a second test result.

In still another embodiment the method comprises routing equipment and personnel, via the processor, based on the treatment priority and the treatment plan assigned for each of the plurality of patients. In still another embodiment the routing is at least one of the following: a unidirectional flow routing, a bi-directional routing, and a hub and spoke routing. In still another embodiment the routing of the plurality of patients to the examination venues is based on input from the real time locating system. In still another embodiment the processor determines a shortest distance and a just-in-time transportation route.

In an embodiment, utilizing state-of-the-art medical knowledge and new and refined systems and methods to estimate degree of injury and/or illness and need for testing and/or treatment, a computer system determines priority order of patients and/or disaster victims for diagnostic and therapeutic procedures. Alternatively and/or additionally, input of information from hospital resources identifies the appropriate sequence, timing, and location of testing and procedures. In another embodiment, real-time-locating-systems technology determines the closest location of available assets i.e., personnel, equipment and supplies and, communicates via electronic messaging, texting, voice command, paging, loudspeaker or any other communications medium, and guides transport and delivery of both patients and assets in the most time-and-distance-efficient manner. In an embodiment, just-in-time delivery minimizes both need for additional inventory of personnel and assets and reduces dwell times during which clinical decompensation may occur. In an embodiment, the primary goal is to manage patients and/or disaster victims in a fashion that maximizes efficiency, effectiveness, quality, and satisfaction of care. Such maximizations results in important and valuable benefit during conditions of routine inpatient clinical volume. Furthermore, such maximizations are of even greater importance and value during periods of high-volume patient surge such as in the aftermath of disasters and other health emergencies.

Hardware, software, and/or firmware capable of collecting, processing and storing in various readable mediums, information from multiple sources, including but not limited to, sensors information, database information, location service information, tracking service information, patient information, mobile data, RFID information, IR sensors, ultra sound sensors and any other pertinent hospital data inputs may be employed to implement the present disclosure. The information may be processed according to a predetermined and updateable set of rules and instructions. The information may be stored and/or distributed locally or over a wired or wireless network to identified recipients. The information may be processed locally or may be processed from a central location where it may be monitored or unmonitored. The information may be gathered from a single source or from multiple sources.

In an embodiment, information is collected from and/or conveyed to a Real-Time-Locating-System that may be capable of identifying the location, type, quantity and direction of movement of inanimate objects, such as medical test equipment, gurneys, wheel chairs, beds, carts, or any other mobile equipment, as well as animate objects, such as patients, technicians, clinicians, doctors, nurses, administrators, or any other medical or administrative personnel involved in managing and/or treating patients or customers. Real-time-locating may be performed in multiple dimensions, such as identified object or person, space and time. Receivers may be located throughout entire facilities or portion of a facility, such as throughout clinical and critical portions of a health care institution. In such a way, staff may be assisted in locating both animate and inanimate objects and resources. Similarly, staff may be tracked and located and directed in a timely and efficient manner. Access to such information may be displayed on heads-up displays, tablets, personal computers, PDAs, smartphones, computers, monitors, or any other display interface. These displays may be located at central locations within the institution such as master processing center or control center, administrative offices, nurses stations, admissions area, intensive care, inpatient units, various testing and treatment locations including, among others, laboratories, imaging centers, surgical suites, etc. Similarly, displays may be portable and carried by staff and/or other designated individuals.

The system and method disclosed herein requires the involvement of appropriately trained staff. Trained staff, with appropriate level of training and experience, will have to participate in the planning, training, and implementation of the disclosed systems and methods because critical medical decisions and treatment plans need to be implemented.

Similarly flow of patients and equipment must be managed in order to prevent grid lock and to allow for increased capacity at the various locations governed by the system such as imaging centers, treatment rooms, surgical suites, and others. In an embodiment, a unidirectional flow model is utilized to ensure that equipment and patients not end up moving in opposite directions causing flow problems and also to facilitate increase in capacity through forward flow of the patients through the institution allowing new patient entry and processing in the locations vacated by the prior patient. Other flow models, such as bi-directional, hub and spoke, central dispatch, etc. may be utilized as well without departing from the spirit of the invention. In an embodiment, movement is under complete control of the master processing center and may be completely automated. Additionally and/or alternatively, flow may be managed by personnel monitoring and directing the movements of people and other assets within the facility.

In an embodiment, multilevel and multifactorial triage information is used to evaluate assessment and reassessment of individuals and is provided as inputs into the system to provide up-to-date and real-time characterization of clinical status. This information, as well as other evaluation information may be gathered from patient surveys, interviews, clinical evaluations and assessments and may be input directly into the system utilizing a wired, or wireless data input device, a manual input or any other system that is capable of collecting and inputting data into a system such as the one disclosed.

The multilevel and multifactorial triage information may use standard triage evaluation techniques or may use enhanced techniques. In an embodiment, enhanced triage evaluation techniques are used. The enhanced techniques require ratings and evaluations of the severity of the illness or injury that are more granular classifications of magnitude and extent of illness, organ system dysfunction, and/or pathophysiologic derangements. In an embodiment, the severity of illness or injury is ranked in a multilevel format by utilizing a detailed assessment of clinical findings. The multilevel format may include as few as three levels of assessment or as many as twenty with a range of 5-10 being preferred. Additionally and/or alternatively, in an embodiment, intensity of illness may be characterized based on a granular delineation of the total amount of disease that needs to be attended to within the stay at the facility and may incorporate not only the severity of illness but also the amount, complexity, and time for services to be rendered to the patient and/or disaster victim. In an embodiment, risk of mortality is used as part of the evaluation. Risk of mortality may include measurements that utilize granular classifications of the likelihood that a patient will succumb to illness or injury during the stay at the facility.

In an embodiment, urgency of illness information is another system input that may be utilized to evaluate and manage patient flow. Urgency of illness information may be determined utilizing granular classifications of the optimal temporal time windows (immediate or other) for needed interventions to prevent further system failures, illness, disability, or death. In various embodiments, other system information inputs may include optimal and maximum time before treatment. This information may be used as a gauge for the appropriate time window within which treatments need to be rendered, should be rendered, and must be rendered. Thresholds, with alarms and reminders, such as a “not-to-exceed temporal failsafe limit” may be generated and presented to the system operator, treating doctors, or other responsible health-care professionals by the system to ensure that critical windows are not missed or exceeded.

Other information and inputs, such as prioritization of testing may be utilized to describe the hierarchy of need for specific testing for any given individual as well as relative needs for testing among individuals competing for available testing slots. This information may be generated by the system based on simple criteria such as who is most critical, or complex algorithms that determine patient criticality. Additionally, and/or alternatively, the system may rely on user input or a combination of user inputs, and system determinations to determine and implement prioritization decisions.

Similarly, prioritization of treatment may be based on a hierarchy of needs for specific treatments for a given individual as well as the relative needs for treatment among individuals competing for the same treatment slots. This hierarchy and its implementation may be generated by the system based on simple criteria such as who is in the most critical condition or it may be based on complex algorithms that determine patient criticality. Additionally, and or alternatively, the system may rely on user input or a combination of user inputs, and system determinations to determine and implement prioritization decisions.

In an embodiment, the system and method comprise a master processing center that acts as a central command, control and communication node and accepts inputs from various hospital-based resources, processes data, and provides direction through outputs to hospital-based resources. The master processing center may be co-located with the facility it serves. Additionally, and/or alternatively, it may be located remotely. In an embodiment, the master processing center or command center may serve more than one facility and may serve a network of related facilities. Facilities may be related geographically, by specialty, by owner or by any other affiliation or characteristic.

The master processing center may comprise a single computer or a network of computers that serve a portion or the entire system. The processing center may comprise a single display for indicating the status of a facility and the flow and control of the facility or it may comprise a number of displays for indicating various components or aspects or facilities within a larger facility or network. The master processing center may be manned or unmanned and may be connected to the facility it controls via a large scale network such as the internet or any other wired or wireless network. In an embodiment, the master processing center or control center is capable of receiving real-time input from hospital-based resources. In an embodiment, such resources may describe and/or summarize the information from hospital-based resources and assets to the master processing center. This information includes, but is not limited to sensor information, database information, location service information, tracking service information, patient information, mobile data, RFID information, IR sensors, ultra sound sensors patient data information, test result information, treatment result information, and any other pertinent hospital data inputs.

In an embodiment, data is processed in real time as well as being stored for later evaluation and simulations. In an embodiment, the real-time processing of data from the various hospital-based resources is utilized to analyze and control efficient and effective clinical and resource management by the control center or master processing center. In an embodiment, real-time output from hospital-based resources, such as sensor information, database information, location service information, tracking service information, patient information, mobile data, RFID information, IR sensors, ultra sound sensors patient data information, test result information, treatment result information, and any other pertinent hospital data inputs may be utilized for the efficient and effective communication of information from the control center to hospital-based resources, including, but not limited to, people and other assets. In an embodiment, the master processing center may utilize system algorithms fed by input data to determine the best treatment options as well as patient and asset flow. In an embodiment, a shortest time-distance algorithm may be utilized, based on the facility and its assets, to predict, model and describe the most efficient way to transport and move patients through the institution from a time and motion perspective. These determinations may include which patients to route to which testing area, what is the shortest route available, which lab has the most available resources, which care giver is available to transport the patient or the equipment, etc.

In an embodiment, just-in-time delivery is utilized in an effort to maximize efficiency. Just-in-time denotes the allocation of human and/or nonhuman resources and/or assets at, substantially at, or very near in time and location to where they are needed within the institution. Such planning and implementation minimizes wait times and the need for additional inventory and maximizes resource allocation to ensure that personnel and equipment is not under-utilized.

In an embodiment, the system may comprise automated processing of animate and inanimate assets to maximize patient care while minimizing need for human and nonhuman resources. The system may operate in an automated manner and may be fully automated or operate under direct human supervision. In an embodiment, the system requires human intervention before any patient critical decisions are reached. Non-critical decisions may be system driven, such as for example selecting which test venue and equipment to use for a particular patient. In an embodiment of the disclosed system, continuous performance improvement is driven by several factors including, but not limited to, the incorporation of best-practices medical evidence as it becomes available and by after-action follow-up of feedback from evaluation of both process and outcome metrics, by improvements in system algorithms, improvements in tracking capabilities, and other hardware and/or software improvements.

In an embodiment, the method and systems metrics related to success or failure may be quantified and/or measured by the central processing center or by a separate application. Such metrics may include the overall length of stay associated with a patient, the cost associated with the treatment and care of a patient, morbidity and mortality measures and statistics, functional status (i.e., the ability to perform specified activities), patient readmission rates, and patient satisfaction with care given.

In an embodiment, a patient or disaster victim or a plurality of patients or victims may present to a health care institution such as a hospital or urgent care facility. If special handling or decontamination is required, for example, as a result of a chemical spill or attack, the patients may undergo decontamination. Next, the master processing or command center determines the current facility capacity (overall and by specific unit) by determining available resources. Facility capacity should be known before patients or victims arrive and such information can be conveyed from the master processing center to emergency personnel to direct and/or reroute as necessary to other facilities.

As patients arrive at the facility, they may be assigned to one of a plurality of evaluation and care venues (“ECV1”) located throughout the facility. Patient admission information may be collected and may include demographics, insurance, next-of-kin, etc. and can be obtained from patients, if possible. As much information as possible is obtained from patients, patient contacts, and response personnel. The information is input into the system and stored in a patient database. The system may assign a specific patient ID number or other designation for each patient which then follows that patient throughout the facility. Patient ID information may be conveyed in many ways including but not limited to bar codes, QR codes, alphanumeric characters, ID bracelets, tags, RFID's or any other means of uniquely identifying a patient.

The patient then may undergo a multimodal assessment (“MA”) which may include a detailed evaluation of the severity, intensity, mortality risk, urgency, appropriate time to treatment, and a special needs assessment. All of this information is entered into the system via any known input device such as a tablet, PDA, direct input, voice recognition, etc and used by the system to evaluate and prioritize patients care. The evaluation can be done at the central control center by the processing system with oversight by trained personnel. The system may make a determination based on data input as to patient priority and applicable testing and/or treatment. The determination may be based on assigning a numerical score to each input and setting threshold levels or may be based on weighted averages, or any other method of ranking.

Based on the determination, an assignment of prioritizations is computed for testing to be conducted and/or treatment to be performed. Also based on the above, a re-evaluation of which treatment and/or evaluation venue, as appropriate, should be used and a clinical environment or need for different environment is determined. The master processing center continuously monitors the respective capacity of each venue and performs an assessment for the availability of each next venue (ECV2) if necessary.

In an embodiment, the master processing center determines equipment prioritization at a facility and coordinates a patient priority hierarchy based on available resources evaluating facilities and patient priority. In an embodiment, a testing prioritization module at the master processing center identifies patient priority hierarchy and schedules testing. In an embodiment, the system determines the necessity of sequential versus non-sequential testing based in part on the patient and/or the availability of resources. If it is determined that testing of a particular patient is warranted, then notifications may be autonomously transmitted to both transport personnel (TRP), equipment personnel (EP) and testing facilities, regarding the need for and location of transportation modality, equipment, and just-in-time delivery of patients and/or assets. Further, testing personnel may be notified of the imminent arrival of a patient so as to prepare in advance of their arrival in order to facilitate and expedited the required testing. The respective testing venues convey real-time testing availability input from testing venues (TeV1, TeV2, etc.) to the master processing center to confirm availability. Based on this information, the master processing center can regulate and manage just-in-time delivery of human and/or nonhuman assets to appropriate available testing venues. In this way, patient waiting is minimized and equipment usage is maximized. Further, if facilities become available, the master processing center may update and reprioritize and/or redirect patients, transport personnel and/or equipment in a real-time manner. The process continues for all required diagnostic tests (DT1, DT2, etc.) as a patient works his/her way through the facility.

In an embodiment, venue capacity assessment may be performed in near real time or real time for all treatment venues (TrV1, TrV2, etc.) and data transmitted to the master processing center for updating of system parameters. Multilevel, multistage triage assessments continue to be performed at appropriate intervals and at multiple steps along the process. As new information is received, it may be input into the master processing center with a resulting recalibration of priority determinations.

In an embodiment, as the master processing center receives the information, it may assign just-in-time delivery of human and/or nonhuman assets to appropriate available treatment venues. Just-in-time delivery and just-in-time transportation is possible based on real-time tracking and real-time location of assets and personnel within the treatment facility. If assets are free, they may be utilized on an as-needed basis in a more efficient manner rather than standing idle because of scheduled time allocation or testing of a less critical patient. For example, a patient that needs an MRI can be transported to an available MRI machine just as it becomes available and precious treatment time is not wasted waiting for a machine to open up. In this manner, as assets and patients are treated through the facility, just-in-time delivery and just-in-time allocation ensure the shortest routes and the quickest most efficient use of resources.

The process continues for all required treatment procedures (TP1, TP2, etc.) as determined by the master processing center and based on re-evaluation of patients and venue as appropriate clinical environment or need for different environment arises.

In an embodiment, the master processing center continues to coordinate process of care through situational awareness from multi-focal inputs and through fine-tuning of patient status in priority hierarchy through multilevel and multistage triage, by coordination of care among all patients and/or disaster victims according to assignment of priority for testing and treatment, and by outputs to the institutional delivery system for just-in-time actions. The master processing center assigns final disposition for each patient and/or disaster victim. In an embodiment, the entire system is automated, but is supervised by trained medical personnel who may override or alter the master processing center decisions as medically necessary.

In an embodiment, the system further allows for after-action follow-up of all process and outcomes metrics to provide continuous feedback and ongoing system performance improvement via enhanced algorithms and changes to triage and patient treatment protocols.

In an embodiment, the Multimodal Assessment (“MA”) used in Multilevel and Multifactorial Triage may be used to determine patient priority assignment

### BRIEF DESCRIPTION OF THE DRAWINGS

FIG. 1 depicts a schematic diagram of a patient care system in accordance with an embodiment of the present disclosure;

FIG. 2 depicts a diagram of the central coordination of inputs and outputs of a patient care system in accordance with an embodiment of the present disclosure;

FIGS. 3a-b depict a Multilevel and Multifactorial Triage and Multimodal Assessment utilized in an embodiment of the present disclosure;

FIG. 4 depicts a flow diagram of the Triage and Multimodal Assessment utilized in an embodiment of the present disclosure;

FIG. 5 depicts the outputs from a master processing center utilizing in accordance with an embodiment of the present disclosure;

FIG. 6 depicts a general purpose computer that may be utilized in an embodiment of the present disclosure.

### DETAILED DESCRIPTION

The present disclosure is directed to systems and methods that rely on medical-evidence-based, real-time-locating-system-enabled, and computer-assisted inputs, processing and outputs to optimize the provisioning of medical care in an inpatient hospital setting. In an embodiment, the systems and methods are based on novel and granular assessments in real-time of the status of various elements of the inpatient care system, effective communication between numerous system nodes, and seamless coordination of multiple parallel processes.

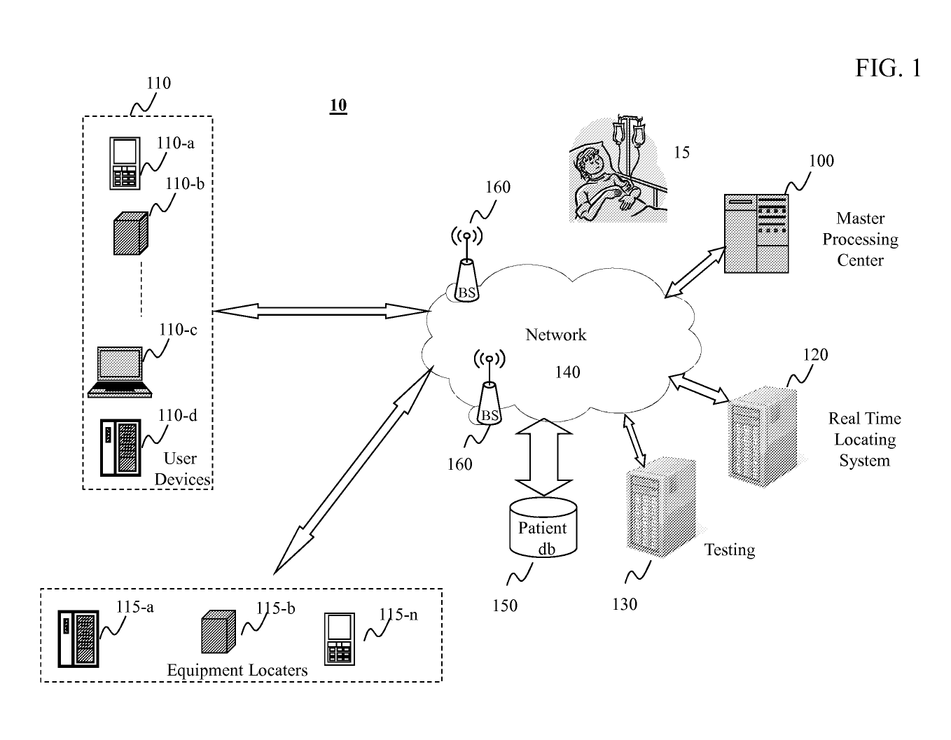

FIG. 1 depicts system 10 comprised of master processing center (MPC) 100, user devices 110, equipment and locater sensors 115, real-time locating system 120, testing system 130, network 140, patient records or database 150, and transceivers 160. In an embodiment, system 10 enables the tracking and treatment of a patient 15 within a care facility. Patient 15 may be outfitted with user device such as handheld device 110a or a patient tracker 110b, transceivers 160 can locate and track patient 15 anywhere within the facility. The location of patient 15 and any associated equipment capable of being tracked, i.e., gurney, wheelchair, etc., may be conveyed to real-time locating system 120. Master processing center 100 records patient information and communicates the information via network 140 to be stored in a patient database 150. Triage and patient evaluation information may be entered via any user device 110 by medical personnel and communicated over network 140 to MPC 100. In an embodiment, the MPC makes a determination on the testing required for patient 15 and conveys the information to real time location system (RTLS) 120 to schedule and route the proper transport equipment and personnel to transport patient 15 to the required testing venue for just-in-time testing. Once testing is complete, the information may be processed by testing system 130 and stored in the associated patient record in database 150. The MPC may then reevaluate the protocol required to treat patient 15 and reallocate the required testing and facilities if necessary.

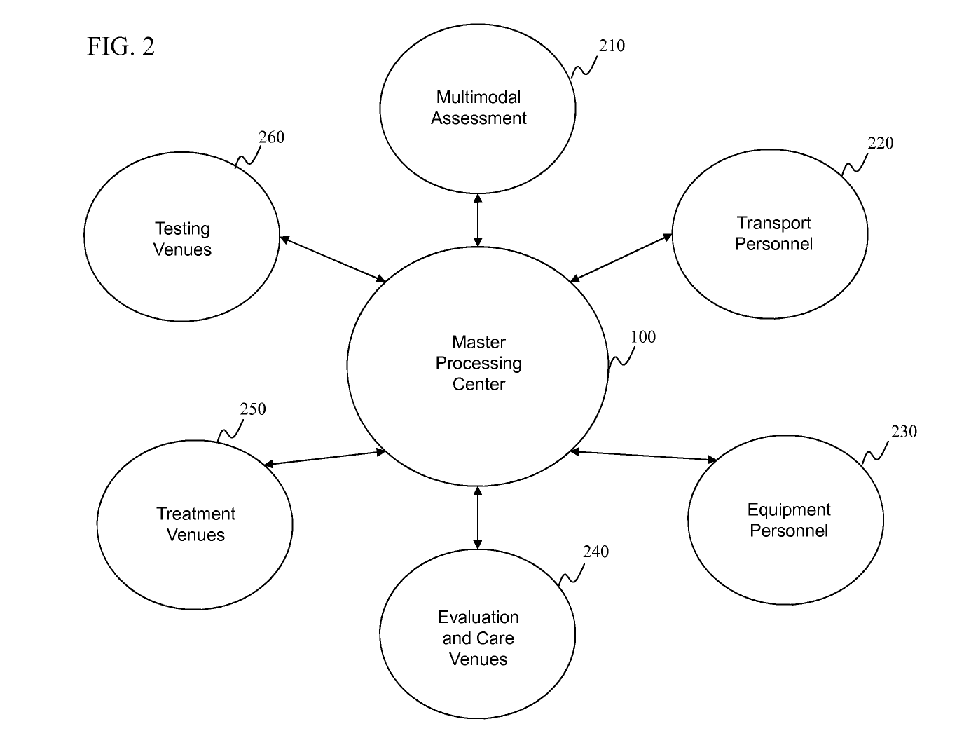

FIG. 2 depicts the central coordination of inputs and outputs of the MPC 100 with the various venues and components of a system in accordance with an embodiment. Master processing center 100 receives informational inputs from multimodal assessments 210 performed by medical personnel, locations and availability of transport personnel 220, locations and availability of equipment and equipment personnel 230, evaluation and care venues 240, treatment venues 250, and testing venues 260.

Multimodal assessments 210 may be performed by medical personnel and may comprise patient evaluations based on severity, intensity, mortality risk, urgency and timing. The evaluation may be comprehensive and involve multi-input evaluations for each category or may be simpler such as a numerical rating scale. The multipoint evaluation information may then be entered into the system 10 via a user device 110 and conveyed to MPC 100 The multimodal assessment may be initially performed upon admittance of patient 15 but may also be performed after treatment or intermediate treatment of patient 15 to evaluate progress and next steps.

In an embodiment, inputs regarding transport personnel 220 may comprise locations and availability of transport personnel to MPC 100. This information may be conveyed as part of a real-time tracking system which utilizes optical recognition, RFID sensors, IR sensors, ultra sound sensors or any other means of locating and monitoring personnel within the facility. Information on personnel may be conveyed via user devices 110 which may be a personal sensor or hand held device. The information may be conveyed to MPC 100 and real-time locating system 120 via transceivers 160 and network 140. Transport personnel can be quickly and efficiently dispatched to the proper location to receive and transport patient 15 to a testing or treatment venue with minimal waiting and down time between patient interactions.

Similarly, equipment personnel 230 can be monitored and dispatched via MPC 100 and real time locating system 120 via transceivers 160 and network 140. For example, a single x-ray technician in testing venue (1) who is not currently working with a patient can be sent to testing venue (2) with different x-ray equipment to perform a test rather than maintaining two technicians with one waiting idle.

Evaluation and care venues 240 may be utilized to initially or subsequently evaluate patients throughout the process. Information, such as patient assessment information may be collected and conveyed back to the MPC from each evaluation venue where the patient is evaluated and/or treated. Similarly, treatment venues 250 may be examination rooms, general or specialized treatment rooms, procedure rooms, surgical suites, operating rooms, bronchoscopy procedure suites, endoscopy procedure suites, cardiac procedure suites, interventional radiology suites, or any other types of treatment facilities the patient traverses. The information on treatment and patient status is conveyed to MPC 100 for continuous patient reevaluation and scheduling.

Testing venues 260 may comprise general laboratories, electrocardiography, stress testing, and other non-invasive cardiology laboratories, vascular laboratories, electroencephalography laboratories, cardiac catheterization laboratories, diagnostic cardiac electrophysiology laboratories, gastrointestinal endoscopy laboratories, pulmonary function laboratories, bronchoscopy laboratories, hematology laboratories, endocrinology laboratories, peripheral angiography laboratories, diagnostic radiology laboratories, magnetic resonance imaging facilities, computerized tomography facilities, positron emission tomography facilities, radiography facilities, ultrasound facilities, or any other types of testing facilities the patient traverses. The testing labs 260 may collect labs and data on patient 15 and process and convey that information to MPC 100, and testing system 130. The information may be processed and associated with patient records in database 150 and used to reevaluate the treatment for patient 15 by MPC 100.

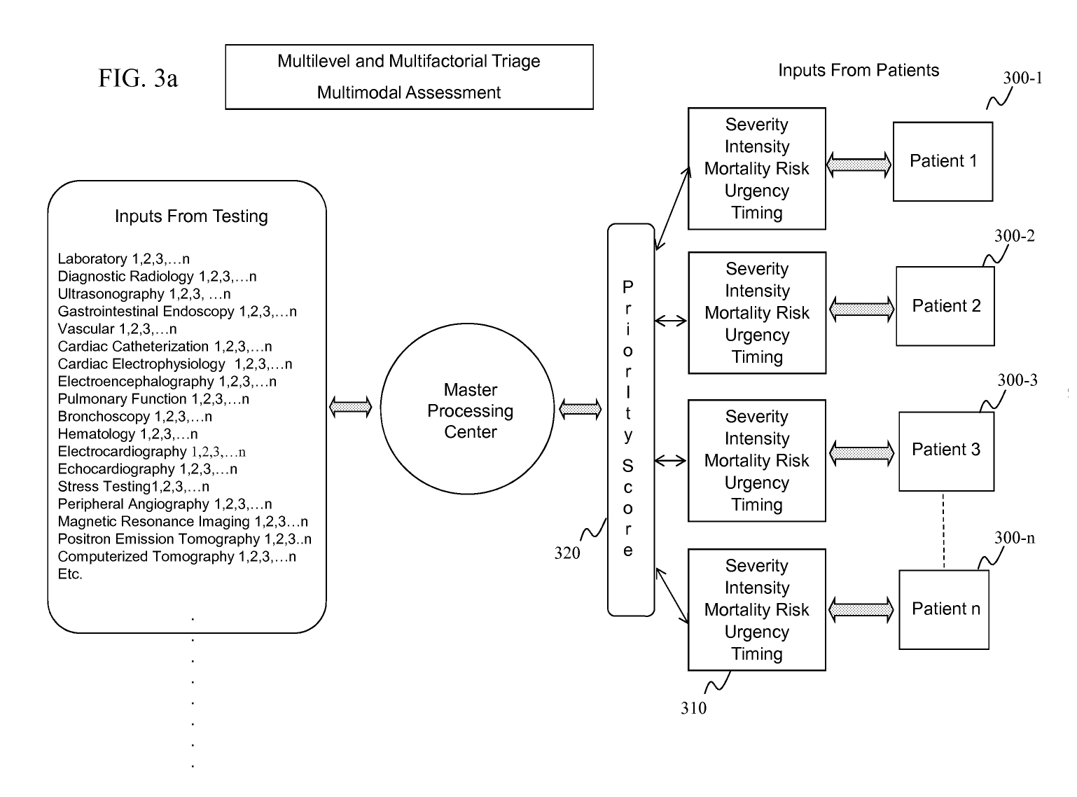

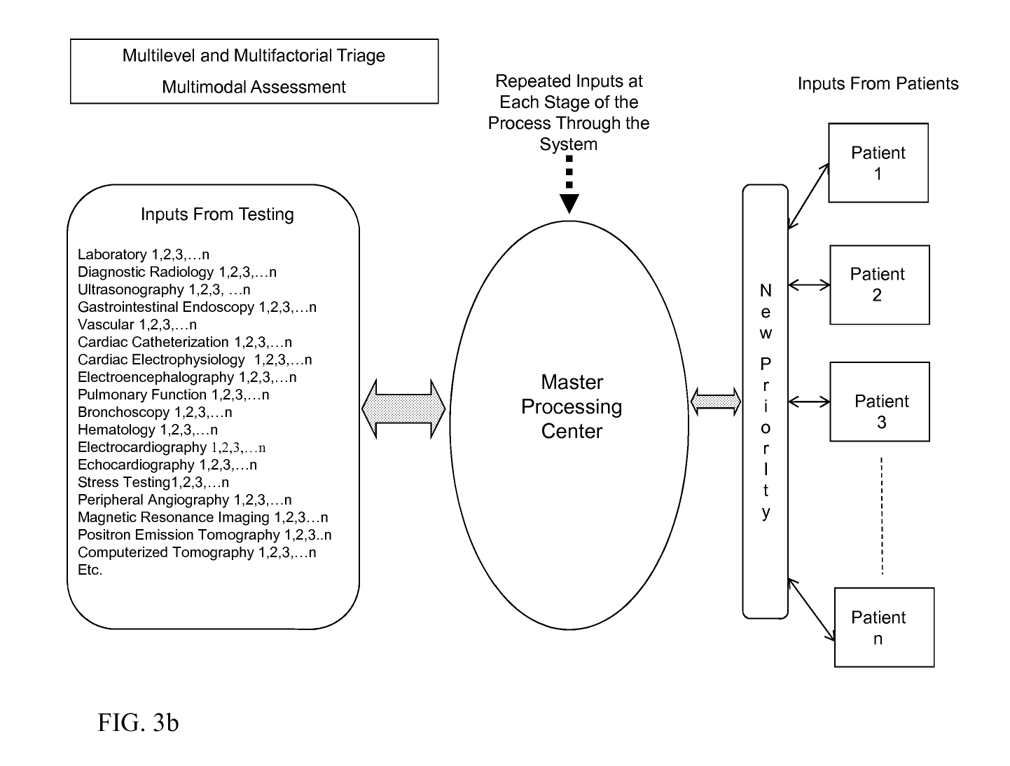

FIG. 3a depicts the multilevel and multifactorial assessment and inputs that may be conveyed to MPC 100 in an embodiment of the present disclosure. As can be seen, a plurality of patients 300-1 to 300-n may be evaluated using a multimodal evaluation 310 and assigned priority scores 320 for input top MPC 100. In an embodiment, inputs from testing venues 260 are also provided to MPC 100 to aid in the evaluation and prioritization of patient treatments and patient control.

FIG. 3b depicts the repetitive and repeated inputs and evaluations performed on patients as they move through the system. As seen in FIG. 3b, each time patient inputs, whether in the form of direct inputs or inputs from testing or evaluation, are received and updated, evaluation and prioritization may take place within the MPC and/or by other evaluators who may reprioritizes patients 1-n for follow up and/or additional testing.

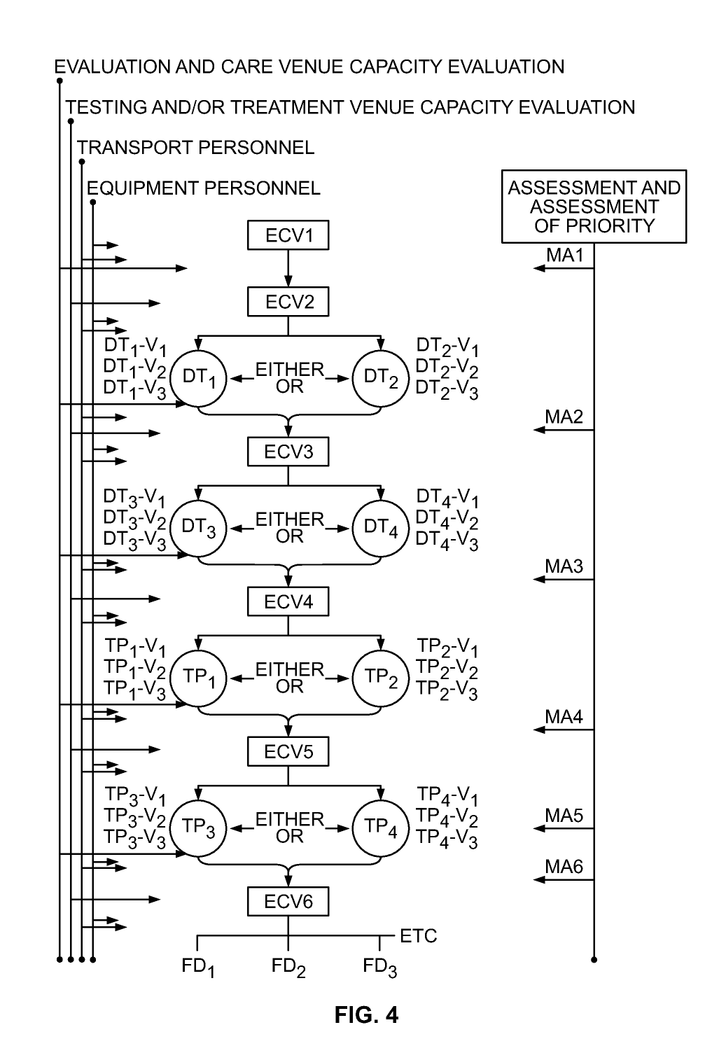

FIG. 4 depicts flow of a patient through a facility utilizing the disclosed system. A patient is evaluated at the first evaluation and care venue (ECV). Initial evaluation and assessment includes care venue capacity evaluation as well as capability evaluation. Also during the initial evaluation, it is determined if there is sufficient testing and/or treatment capacity and equipment and personnel available to properly treat the incoming patient. If it is determined that there is sufficient capacity, the patient may be advanced to ECV 2 for further evaluation and or treatment. Diagnostic tests will be performed (DT1/DT2) and the patients reassessed and advanced to the next ECV center for additional evaluation. As will be understood by those skilled in the art, at each ECV, the master processing center determines treatment options and availability of personnel and equipment, as well as decision-making on just-in-time delivery and testing options to ensure coordinated treatment and movement throughout the facility.

The following abbreviations may be used with respect to FIG. 4 and/or other figures in the application. MPC—Master Processing Center; MA—Multimodal Assessment; ECV—Evaluation and Care Venues; TeV—Testing Venues; TrV—Treatment Venues; TRP—Transport Personnel (patient transport services); EP—Equipment Personnel (equipment retrieval and transport services); PT—Patient (PT1 is patient #1, etc.); RTLS—Real-Time-Locating-System; DT—Diagnostic Tests (performed at Testing Venues based upon best medical practices); and TP—Treatment Procedures (performed at Treatment Venues based upon best medical practices).

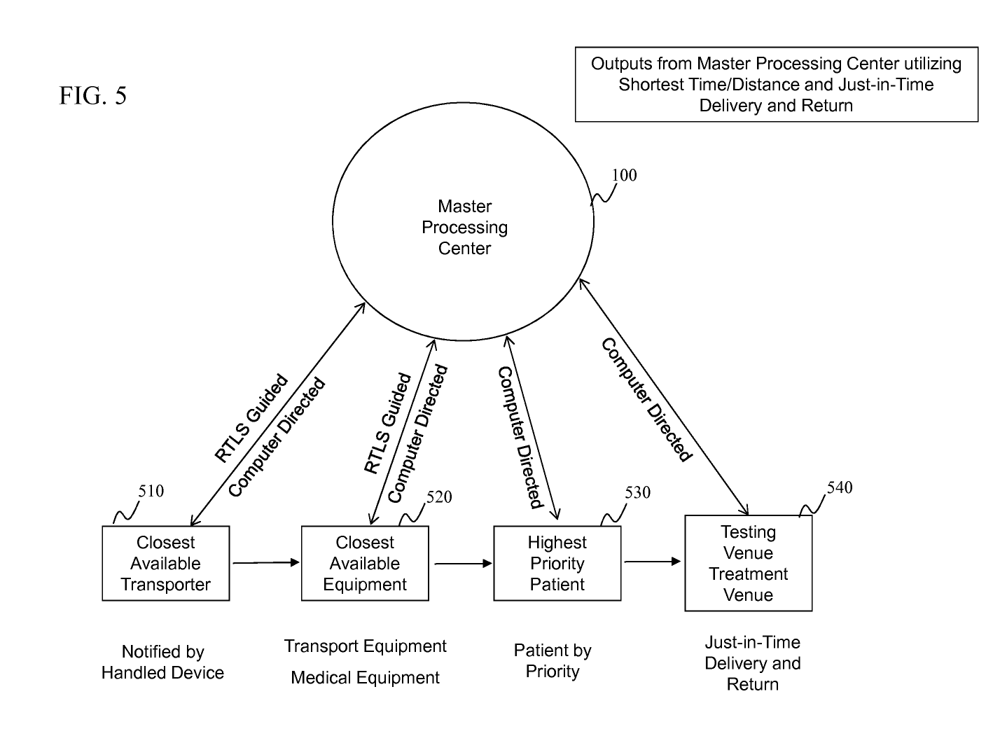

FIG. 5 depicts the outputs from the MPC utilizing shortest time/distance and just-in-time delivery and return options. As seen, the MPC 100 communicates computer-directed RTLS-guided outputs to the closest available transporter 510 or transporter dispatch. The transporter may be contacted via a handheld device 110 such as a pager, smart phone, display screen, or PDA, and directed to pick up transport equipment and/or medical equipment 520. Next, the transporter may be directed to transport the highest priority patient 530 via the shortest and quickest distance to the testing venue or treatment venue 540. Throughout the process, MPC 100 receives inputs from the transport operators regarding location and availability; from the equipment, testing, and treatment facilities regarding availability and operability; and from the various evaluation centers regarding patient evaluation to determine priority.

As will be understood by those skilled in the art, the systems and methods disclosed herein may be performed on a single computer or server over a single network or may be performed on a plurality of computers communicating via local or wide area networks. Communications may be via wired or wireless equipment and inputs and outputs may be received or transmitted via various wired or wireless formats without departing from the spirit of the invention.

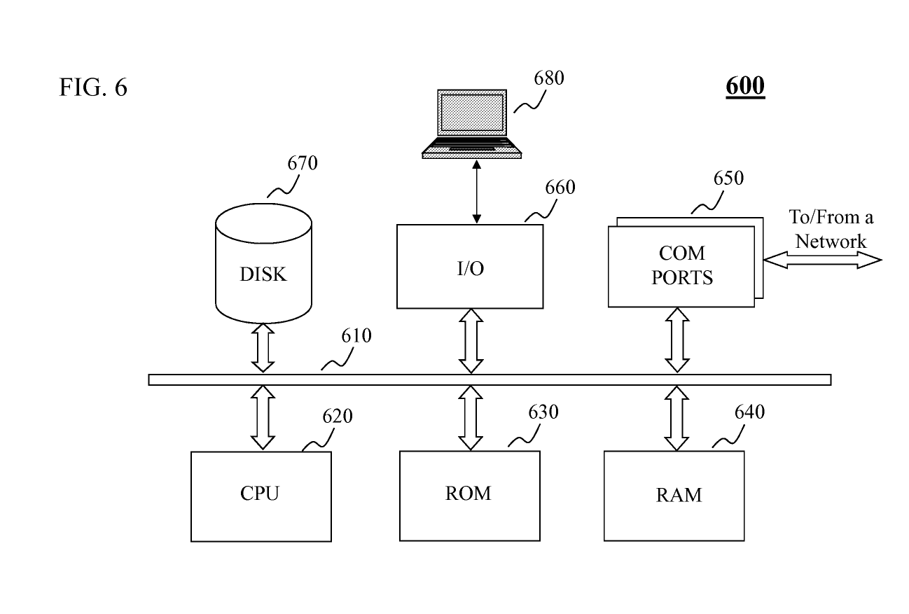

FIG. 6 depicts a general computer architecture on which the present teaching can be implemented and has a functional block diagram illustration of a computer hardware platform that includes user interface elements. The computer may be a general-purpose computer or a special purpose computer. This computer 600 can be used to implement any steps of the method as described herein. It may be used to evaluate and prioritize patients and diagnostic and treatment plans, order tests, route personnel and equipment, and any other step or process that may be automated. Different steps can all be implemented on one or more computers such as computer 600, via its hardware, software program, firmware, or a combination thereof. Although only one such computer is shown, for convenience, the methods disclosed herein may be implemented in a distributed fashion on a number of similar platforms, to distribute the processing load.

The computer 600, for example, includes COM ports 602 connected to and from a network connected thereto to facilitate data communications. The computer 600 also includes a central processing unit (CPU) 604, in the form of one or more processors, for executing program instructions. The exemplary computer platform includes an internal communication bus 606, program storage and data storage of different forms, e.g., disk 608, read only memory (ROM) 610, or random access memory (RAM) 612, for various data files to be processed and/or communicated by the computer, as well as possibly program instructions to be executed by the CPU. The computer 600 also includes an I/O component 614, supporting input/output flows between the computer and other components therein such as user interface elements 616. The computer 600 may also receive programming and data via network communications.

Hence, aspects of the method disclosed herein, as outlined above, may be embodied in programming. All or portions of the software may at times be communicated through a network such as the Internet or various other telecommunication networks.

Those skilled in the art will recognize that the present teachings are amenable to a variety of modifications and/or enhancements. For example, although the implementation of various steps may be performed manually, they may also be implemented as part of an automated process and carried out by a computer or other automation operation.

While the foregoing has described what are considered to be embodiments and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A system for managing treatment of a plurality of patients in a facility comprising:
an input device for inputting a status of the plurality of patients;
a processor for determining a treatment priority for the plurality of patients based on the input;
assigning, via the processor, the treatment priority to each of the plurality of patients;
generating, via the processor, a treatment plan for each of the plurality of patients; and
a real time locating system for monitoring and tracking equipment and personnel within the facility;
allocating, via the real time locating system, equipment and personnel to implement the treatment plan for each of the plurality of patients; and
implementing, via the processor, for the plurality of patients, based on the assigned treatment priority and the allocating of equipment and personnel, the treatment plan.

2. The system of claim 1 wherein the status is a health status determined by a multilevel assessment.

3. The system of claim 1 wherein the status is updated a plurality of times during the treatment plan.

4. The system of claim 3 wherein the status update is based on a test run on one of the plurality of patients.

5. The system of claim 1 comprising a testing system, wherein the testing system maintains the status of the plurality of patients.

6. The system of claim 1 comprising a plurality of evaluation venues to collect the status of the plurality of patients and to provide the collected status to a testing system or the processor.

7. The system of claim 1 wherein the allocating of equipment and personnel to implement the treatment plan for each of the plurality of patients is controlled by the processor.

8. A system for treating a plurality of patients comprising
a master processing center;
an examination venue; and
a real time locating system;
wherein data from the examination venue, and the real time locating system is provided to the master processing system, and
wherein the master processing center determines a treatment plan for the plurality of patients based on the data.

9. The system of claim 8 where the examination venue is selected from at least one of the following;
a testing venue, a treatment venue and an evaluation and care venue.

10. The system of claim 9 wherein the testing venue is selected from at least one of the following:
a general laboratory, a non-invasive cardiology laboratories, a vascular laboratory, an electroencephalography laboratory, a cardiac catheterization laboratory, a diagnostic cardiac electrophysiology laboratory, a gastrointestinal endoscopy laboratory, a pulmonary function laboratory, a bronchoscopy laboratory, a hematology laboratory, an endocrinology laboratory, a peripheral angiography laboratory, a diagnostic radiology laboratory, a magnetic resonance imaging facilities, a computerized tomography facility, a positron emission tomography facility, a radiography facility, and a ultrasound facility.

11. The system of claim 9 wherein the testing venue is selected from at least one of the following:
an examination room, a general or specialized treatment room, a procedure room, a surgical suites, an operating room, a bronchoscopy procedure suite, an endoscopy procedure suite, a cardiac procedure suites, and an interventional radiology suite.

12. A method, implemented on a processor, a communications network, for managing the treatment of a plurality of patients in a facility comprising:
inputting to the processor, via an input device, a status of the plurality of patients;
determining, via the processor, based on the inputting, a treatment priority for the plurality of patients;
assigning the treatment priority to each of the plurality of patients;
selecting, via the processor, a treatment plan for each of the plurality of patients;
tracking equipment and personnel within the facility via a real time locating system located at the facility;
allocating the equipment and personnel to implement the treatment plan.

13. The method of claim 12 comprising testing the patients in an examination venue, and outputting a test result to be used as input for the processor.

14. The method of claim 13 where the examination venue is selected from at least one of the following;
a testing venue, a treatment venue and an evaluation and care venue.

15. The method of claim 12 wherein the treatment plan is based on the test result.

16. The method of claim 13 further comprising a second testing and an update to the treatment plan based on a second test result.

17. The method of claim 12 comprising routing equipment and personnel, via the processor, based on the treatment priority and the treatment plan assigned for each of the plurality of patients.

18. The method of claim 17 where the routing is at least one of the following:
a unidirectional flow routing, a bi-directional routing, and a hub and spoke routing.

19. The method of claim 17 where the routing of the plurality of patients to the examination venues is based on input from the real time locating system.

20. The method of claim 17 wherein processor determines a shortest distance and a just-in-time transportation route.
